(19) United States
(12) Patent Application Publication
(10) Pub. No.: US 2013/0008471 A1
(43) Pub. Date: Jan. 10, 2013

(54) Device for Unclogging Pipe

(76) Inventor: Jay Richard Borkowski, Raleigh, NC (US)

(21) Appl. No.: 13/534,087

(22) Filed: Jun. 27, 2012

Related U.S. Application Data
(60) Provisional application No. 61/571,801, filed on Jul. 6, 2011.

(51) Int. Cl. B08B 9/055

(52) U.S. Cl. 134/22.12; 134/166 C

(57) ABSTRACT

A flexible tubing system includes flexible tubing and a balloon. The balloon is located at the flexible tubing's distal end and between the opening of the proximate end and the opening of the distal end. The distal end of flexible tubing is inserted into a pipe so that the balloon is surrounding by pipe walls. The balloon is inflated by forcing air or liquid into an air/fluid injection port at the proximate end of the flexible tubing until the balloon creates a substantially airtight blockage in the pipe, thereby creating an interstitial space between the inflated balloon and the clog. Then, air or fluid is injected through the opening at the proximate end of the flexible tubing to exit at the opening of the distal end of the flexible tubing thereby pressurizing the interstitial space and forcing the clog to move away from the balloon to unclog the pipe.

### CROSS-REFERENCE TO RELATED APPLICATION

This application is a non-provisional application of, and claims priority from co-pending, commonly owned provisional application Ser. No. 61/571,801 filed Jun. 30, 2011, the entire contents of each of the above are incorporated herein by reference.

### BACKGROUND

Pipes are used for various purposes, mainly for the transportation of air, fluids, and/or solids. Sometimes a pipe may become clogged. Because pipes are generally long and relatively small in diameter, access to the interior of pipes to unclog these pipes creates a real challenge. Plumbers and others typically do not want to cut the pipe at the location of the clog due to damaging of the pipe and expenses of replacing or repairing the pipe.

Chemicals are sometimes used to dissolve the clog in a pipe. These chemicals work to a certain extent but are environmentally unfriendly and can take a long time to work (if at all) and are expensive.

Other methods relate to pulling a clog out of the drain, but this is extremely messy and unappealing to a user. Additionally, this is difficult and many times not only ineffective but inefficient.

### BRIEF SUMMARY

To solve the above identified problems, the present invention relates to tubing that has a balloon on one end of the tubing. The end of the tubing with the balloon is inserted into the pipe. The balloon is inflated to create an airtight blockage. The user then forces air or liquid through the tube to force the clog down the drainage pipe.

According to one aspect of the present invention, a method for unclogging a drain is provided. A flexible tubing system is provided that may include a flexible tubing and a balloon. The flexible tubing may include a distal end, a proximate end, an opening at the distal end, an opening at the proximate end and an interior cavity that allows for fluid communication from the opening at the proximate end and the opening at the distal end. The balloon may include walls and an interior cavity, whereby the balloon may be located at the distal end of the flexible tubing and between the opening of the proximate end and the opening of the distal end. The distal end of flexible tubing is inserted into the pipe so that the balloon is inserted into the pipe to the point that the balloon is surrounding by pipe walls. The balloon is inflated by forcing air or liquid into air/fluid injection port at the proximate end of the flexible tubing until the balloon creates a substantially airtight blockage in the pipe with the walls that surround the balloon, thereby creating an interstitial space between the inflated balloon and the clog; Once the balloon is inflated, air or fluid is injected through the opening at the proximate end of the flexible tubing to exit at the opening of the distal end of the flexible tubing thereby pressurizing the interstitial space and forcing the clog to move away from the balloon to unclog the pipe.

According to another aspect of the present invention, a system for unclogging a drain pipe is provided. The system may include a flexible tubing, a balloon and an air/fluid injection port. The flexible tubing comprises a distal end, a proximate end, an opening at the distal end, an opening at the proximate end and an interior cavity that allows for fluid communication from the opening at the proximate end and the opening at the distal end. The balloon comprises walls and an interior cavity. The balloon may be located at the distal end of the flexible tubing and between the opening of the proximate end and the opening of the distal end. The balloon filling port is configured to allow for the balloon to be inflated/deflated such that when the balloon is inserted into a pipe and inflated. The balloon may create a substantially airtight seal between pipe walls directly surrounding the balloon and walls of the balloon, thereby creating an interstitial space between the inflated balloon and the clog. The air/fluid injection port allows for fluid communication from the proximate end of the flexible tubing through the distal end of the flexible tubing such that once the balloon is inflated. Air or fluid is forcefully injected through the opening at the proximate end of the flexible tubing to exit at the opening of the distal end of the flexible tubing thereby pressurizing the interstitial space and forcing the clog to move away from the balloon to unclog the pipe.

### BRIEF DESCRIPTION OF THE SEVERAL VIEWS OF THE DRAWINGS

Aspects of the present invention are further described in the detailed description which follows in reference to the noted plurality of drawings by way of non-limiting examples of embodiments of the present invention in which like reference numerals represent similar parts throughout the several views of the drawings and wherein:

FIG. 1 is a side view of a flexible tubing system in accordance with an embodiment of the present invention.

FIG. 2 is a side cross-sectional view of a pipe with the flexible tubing system of FIG. 1 removing a clog in the pipe in accordance with an embodiment of the present invention.

FIG. 3 is a flowchart of an example of a method for unclogging a drain in accordance with an embodiment of the present invention.

### DETAILED DESCRIPTION

Aspects of the present invention are described below with reference to flowchart illustrations and/or block diagrams of methods, apparatus (systems) and computer program products according to embodiments of the invention.

In accordance with an aspect of the invention, solutions for unclogging a pipe are disclosed and will now be generally introduced. Some aspects of the invention relate to a device and method for unclogging drain pipes by using a device comprised of a flexible tube with two internal lumens and an externally attached inflatable balloon. The flexible tube is inserted in the pipe, a balloon is inflated and air/fluid is injected into an interstitial space created between the balloon and the clog forcing the clog to move away from the balloon.

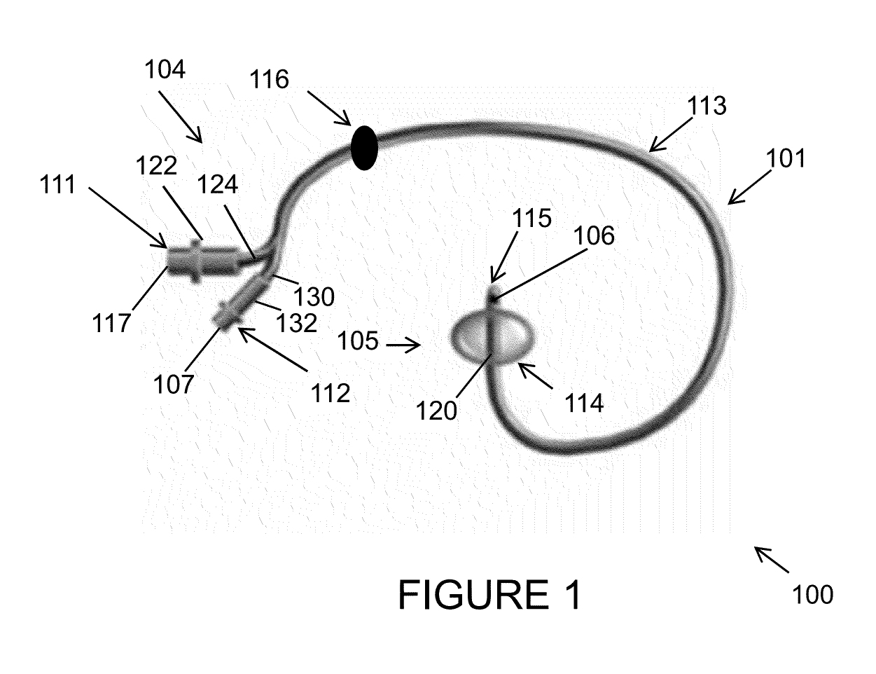

The above concept is generally depicted in FIGS. 1-3, according to some embodiments. FIGS. 1-3 are discussed below.

FIG. 1 illustrates a flexible tubing system 100 according to some embodiments. The flexible tubing system 100 may include a flexible tubing 101, a balloon 114, a balloon filling port 112, and an air/fluid injection port 111.

The flexible tubing 101 may include a proximate end 104, a distal end 105, an opening 106 at the distal end 105, an opening 107 at the proximate end 104 and an interior cavity within the flexible tubing 101 that allows for fluid communication from the opening 107 at the proximate end 104 through an interior cavity/vessel to the opening at the distal end 105.

The flexible tubing may be a double lumen 113 that is made from a polymer or copolymer based material that allows for two tubes to flow from the proximate end 104 and the distal end 105 of the flexible tube 101 according to one embodiment. Each of the lumens of the double lumen 113 is separate from each other so that the interior cavity of each lumen is not in fluid communications with each other. In another embodiment (not graphically illustrated), the flexible tubing may be a single lumen that allows for fluid flow from the proximate end 104 and the distal end 105 of the flexible tube 101, and the balloon can be inflated in any other means other than described above.

Regardless, the flexible tubing 101 may be flexible enough to navigate down a sink drain and through a trap of a drainage pipe without kinking while containing sufficient tensile strength to enable the flexible tubing 101 to be manually advanced through a pipe bend. The length of the flexible tubing 101 may be greater than fourteen inches and less than twenty-four inches according to an embodiment. The outer diameter of the flexible tube 101 may be approximately ⅛ of an inch.

It should be understood that the flexible tubing 101 need not be flexible and instead could be a substantially rigid tube that is substantially inflexible according to one embodiment.

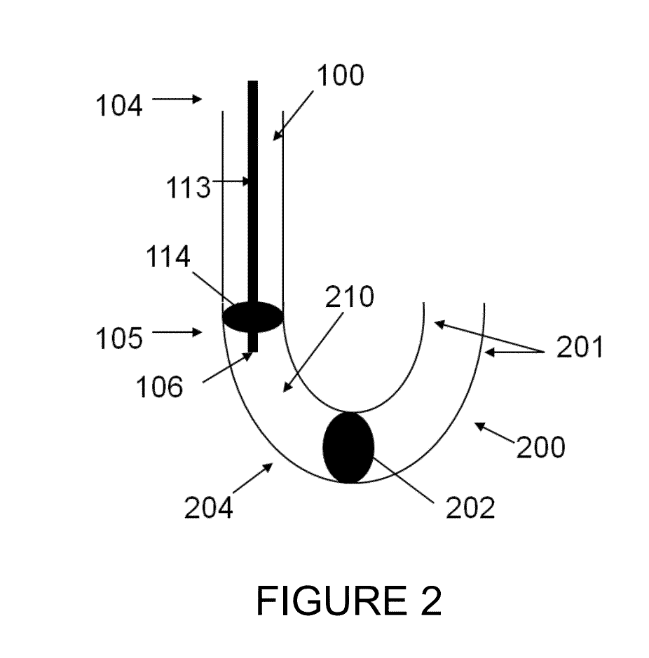

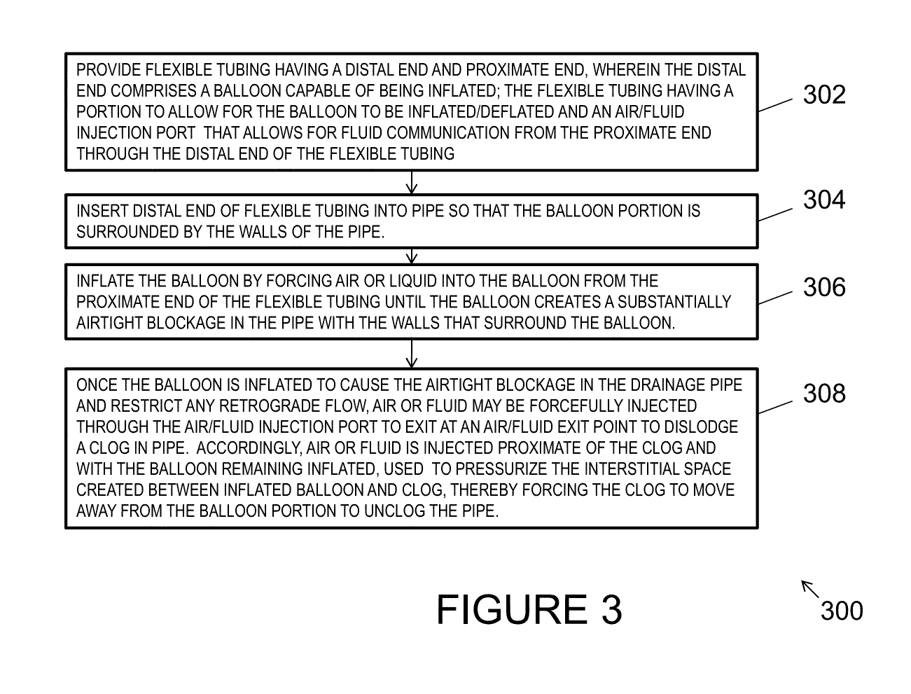

The balloon 114 includes walls and an interior cavity. The walls are flexible so that the balloon's interior cavity can volumetrically expand and contract. Additionally, when the balloon is inflated, the walls are configured to conform to the walls of surrounding pipe so that air or fluid on one side of the inflated balloon does not flow to the another side of the inflated balloon, as will be discussed in more detail with regard to FIGS. 2-3.

A first lumen of double lumen 113 may be used for the inflation of the balloon 114 located at the distal end 105 of the flexible tube 101. The first lumen has a first end and a second end. The second end may be connected with the balloon 114 and the first end may be the balloon filling port 112.

The balloon 114 may be located at the distal end 105 of the flexible tubing 101. The balloon 114 is located between the opening of the proximate end and the opening of the distal end so that when the balloon is inflated, fluid can flow from one side of the inflated balloon 114 to the other side of the inflated balloon 114 into an interstitial cavity between the balloon and a clog in the pipe, as is discussed in FIG. 2. As illustrated in FIG. 1, the opening 106 of distal end 105 is on one side of balloon 114 and the opening 107 of the proximate end 104 is located on another side of balloon 114.

The balloon 114 may be made of silicone or similarly expandable material that is resistant to decay when exposed to the types of caustic materials used in the manufacturing of fluids to unclog drainage pipes. The balloon 114 is attached to the exterior of the flexible tubing 101 with an adhesive or thermal process. Prior to inflation, the balloon 114 maintains a low profile around the flexible tubing 101. As previously mentioned, the balloon 114, when fully inflated, then expands to compress against the inner diameter walls of the drainage pipe proximal to where the clog is located.

The balloon filling port 112 is configured to allow for the balloon 114 to be inflated/deflated such that when the balloon 114 is inserted into a pipe and inflated, the balloon creates a substantially airtight seal between pipe walls directly surrounding the balloon 114 and walls of the balloon 114, thereby creating an interstitial space between the inflated balloon and the clog.

The air/fluid injection port 111 allows for fluid communication from an air/fluid injection opening 117 in the proximate end 104 of the flexible tubing 101 through an air/fluid exit opening 120 at the distal end 105 of the flexible tubing such that once the balloon 114 is inflated, air or fluid is forcefully injected through the opening at the proximate end of the flexible tubing to exit at the opening of the distal end of the flexible tubing thereby pressurizing the interstitial space and forcing the clog to move away from the balloon to unclog the pipe. An example of this process is discussed below.

In one embodiment, a connector 122 with a one-way valve at the proximal end of the balloon inflation lumen 124 allows for a standard syringe (not shown) to be attached or inserted. The syringe may then be used to inject air (or other gas or fluid) into the balloon 114 by terminating the distal end of the lumen 124 under the region where the balloon is attached through an exit hole 120. When the syringe is detached, the one way valve connector 122 does not allow the air that was injected into the balloon 114 to escape the balloon, thereby allowing the balloon to maintain inflation. The balloon remains inflated until the syringe is inserted at the end of the process allowing for the removal of the device from the pipe.

As mentioned previously, the double lumen 113 may include a second lumen 130 for the injection of air or fluid into the interstitial space between the inflated balloon and the clog in the pipe. The second lumen 130 may have a luer lock connector 132 at the proximal end of the second lumen 130 so another syringe can be securely attached. This second lumen 130 is used for the injection of air or liquid through the entire length of the flexible tubing 101 terminating at the opening 106 at the distal end 105 of the flexible tube 101. As mentioned above, the first lumen 124 and second lumen 130 do not share an interior cavity but their outer walls may be attached to each other so that the first and second lumens are attached to each other according to some embodiments.

The flexible tubing system 100 may also contain a movable grommet 116 capable of sliding along the length of the flexible tubing 101 to allow for the measurement and recording of how much of the flexible tubing 101 needs to be inserted into the pipe to reach the clog.

FIGS. 2-3 illustrate the flexible tubing system 100 in operation to remove a clog 202 from a pipe 200. Also as mentioned above, the inflation of the balloon 114 creates an interstitial space 210 that is distal to the inflated balloon 114 and proximal to the clog 202. With the creation of this interstitial space 210, when air or fluid is injected through the second lumen 130, the injected air or fluid exits out the opening 106 of the second lumen 130 where the opening 106 is located within the interstitial space 210. Since the inflated balloon 114 that is compressed against the inner walls 201 of the pipe 200 inhibits any retrograde flow back up the pipe 200 toward the proximate end 104 of the flexible tubing 101, the forceful introduction of the additional air or fluid into the interstitial space 210 generates sufficient pressure to force the clog 202 to be dislodged.

The flexible tubing system 200 also allows for the injection of fluid used to unclog drains directly at the location of the clog. The fluid is then blocked from flowing in a retrograde fashion by the inflated balloon. By restricting the fluid from flowing away from the clog and forcing it to remain in direct contact with the clog, the amount of fluid required to clear the clog may be reduced as well as reducing the amount of time required for the fluid to be effective, having both an environmental benefit and reducing the time required to unclog the drain.

FIG. 3 illustrates a method for unclogging a drain in accordance with an embodiment of the invention. In block 302, a flexible tubing system as discussed above with regard to FIG. 1 is provided. For example, provided is the flexible tubing having a distal end and proximate end, wherein the distal end comprises a balloon capable of being inflated, whereby the flexible tubing may include a portion to allow for the balloon to be inflated/deflated and an air/fluid injection port that allows for fluid communication from the proximate end through the distal end of the flexible tubing.

In block 304, one inserts the distal end of flexible tubing into the pipe so that the balloon portion is surrounded by the walls of the pipe. To accomplish this, according to an embodiment, the device is held along the length of the pipe containing the clog so that the tip of the tube is at the bottom of the pipe “trap”. The grommet (if included) is then slid toward the clog in the pipe to indicate the distance from the drain (e.g., the pipe beginning) to the location of the clog. The opening 106 of the distal end of the flexible tubing 101 is manually inserted into the opening of the pipe at the drain, and advanced into the pipe until the grommet reaches the drain indicating that the opening 106 of the distal end of the flexible tubing 101 has reached the location of the clog.

In block 306, one inflates the balloon by forcing air or liquid into the balloon from the proximate end of the flexible tubing until the balloon creates a substantially an airtight blockage in the pipe with the walls that surround the balloon. To do this, according to an embodiment, an approximately 60 cc syringe that is filled with air may be attached to the balloon inflation port connector (i.e., air/fluid injection port 117 of FIG. 1). The air is injected through the air/fluid injection port 117 to fully inflate the balloon 114 so that the balloon walls expand tightly against the pipe walls immediately surrounding the balloon 114 so that an airtight blockage is created. The syringe is then disconnected from the air/fluid injection portion 117 leaving the balloon 114 inflated within the pipe.

In block 307, once the balloon is inflated to cause the airtight blockage in the drainage pipe and restrict any retrograde flow therein, air or fluid may be forcefully injected through the air/fluid injection port to exit at an air/fluid exit point to dislodge a clog in pipe, as discussed below.

According to one embodiment, a syringe may be filled with either air or fluid and attached to the air/fluid injection port connector 122. Once attached, the contents of the syringe are forcefully injected through the air/fluid injection port 111 to dislodge the clog in the pipe by creating increased pressure in the interstitial space 210 created between the clog 202 and the inflated balloon 114. This process may need to be repeated several times before the clog 202 is actually dislodged.

It should be noted that a syringe need not be the only device or method of injecting air or fluid. One may use any other means, such as a person blowing on the air/fluid injection port 122 to fill the interstitial space with air, a pump mechanism to fill the air/fluid injection port 122 with fluid/gas, or any other device which can provide fluid/gas in the air/fluid injection port 122 to fill the interstitial space with gas or fluid.

In another embodiment, a syringe may be filled with fluid used to unclog drains and attached to the air/fluid injection port connector 122. Once attached, the contents of the syringe are injected through the air/fluid injection port 122 to fill the interstitial space created between the clog and the inflated balloon 114 with the fluid. By injecting the fluid and restricting it to be held in the interstitial space 210 created between the clog 202 and the inflated balloon 114 and therefore, in contact with the clog 202, the volume of fluid required to unclog the drain is minimized compared to the amount of fluid recommended to be poured down the drain by the fluid manufacturer. By reducing the volume of fluid used, costs are reduced and the environment benefits.

When the clog 202 is dislodged, the syringe may detached from the air/fluid injection port connector 122 and reattached to the balloon inflation port connector which engages the one way valve connector allowing the balloon 114 to deflate. The device can then be removed from the pipe by retracting it through the drain.

Accordingly, the above discussed embodiments, declogs a drainage pipe. Air or fluid is injected proximate of the clog and with the balloon remaining inflated, used to pressurize the interstitial space created between inflated balloon and clog, thereby forcing the clog to move away from the balloon portion to unclog the pipe.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for unclogging a pipe comprising:
providing a flexible tubing system comprising:
a flexible tubing comprising a distal end, a proximate end, an opening at the distal end, an opening at the proximate end and an interior cavity that allows for fluid communication from the opening at the proximate end and the opening at the distal end; and
a balloon comprising walls and an interior cavity, the balloon being located at the distal end of the flexible tubing and between the opening of the proximate end and the opening of the distal end;
inserting the distal end of flexible tubing into pipe so that the balloon is inserted into the pipe to the point that the balloon is surrounding by pipe walls;
inflating the balloon by forcing air or liquid into air/fluid injection port at the proximate end of the flexible tubing until the balloon creates a substantially an airtight blockage in the pipe with the walls that surround the balloon, thereby creating an interstitial space between the inflated balloon and the clog;
injecting, once the balloon is inflated, air or fluid through the opening at the proximate end of the flexible tubing to exit at the opening of the distal end of the flexible tubing thereby pressurizing the interstitial space and forcing the clog to move away from the balloon to unclog the pipe.

2. The method of claim 1, wherein the flexible tubing system further comprises a balloon filling port configured to allow for the balloon to be inflated/deflated.

3. The method of claim 2, wherein the balloon filling port is located at the proximate end of the flexible tubing

4. The method of claim 2, wherein the balloon is integral to the flexible tubing such that the interior cavity of the balloon is in fluid communication with the balloon filling portion.

5. The method of claim 2, wherein the flexible tubing system further comprises a balloon filling vessel that fluidly connects the balloon filling port to the balloon interior cavity, the balloon filling vessel being separate from the interior cavity of the flexible tubing.

6. The method of claim 1, wherein the opening at the proximate end comprises an air/fluid injection port that allows for fluid communication from the proximate end of the flexible tubing through the distal end of the flexible tubing.

7. The method of claim 5, wherein the flexible tubing system further comprises a balloon filling port configured to allow for the balloon to be inflated/deflated, the balloon filling portion port is separate from the air/fluid injection port.

8. A system for unclogging a pipe, the system comprising:
a flexible tubing comprising a distal end, a proximate end, an opening at the distal end, an opening at the proximate end and an interior cavity that allows for fluid communication from the opening at the proximate end and the opening at the distal end;
a balloon comprising walls and an interior cavity, the balloon being located at the distal end of the flexible tubing and between the opening of the proximate end and the opening of the distal end;
a balloon filling port configured to allow for the balloon to be inflated/deflated such that when the balloon is inserted into a pipe and inflated, the balloon creates a substantially airtight seal between pipe walls directly surrounding the balloon and walls of the balloon, thereby creating an interstitial space between the inflated balloon and the clog; and
an air/fluid injection port that allows for fluid communication from the proximate end of the flexible tubing through the distal end of the flexible tubing such that once the balloon is inflated, air or fluid is forcefully injected through the opening at the proximate end of the flexible tubing to exit at the opening of the distal end of the flexible tubing thereby pressurizing the interstitial space and forcing the clog to move away from the balloon to unclog the pipe.

9. The system of claim 8, further comprising a balloon filling port configured to allow for the balloon to be inflated/deflated.

10. The system of claim 9, wherein the balloon filling port is located at the proximate end of the flexible tubing

11. The system of claim 9, wherein the balloon is integral to the flexible tubing such that the interior cavity of the balloon is in fluid communication with the balloon filling portion.

12. The system of claim 9, further comprising a balloon filling vessel that fluidly connects the balloon filling port to the balloon interior cavity, the balloon filling vessel being separate from the interior cavity of the flexible tubing.

13. The system of claim 8, wherein the opening at the proximate end comprises an air/fluid injection port that allows for fluid communication from the proximate end of the flexible tubing through the distal end of the flexible tubing.

14. The system of claim 13, further comprising a balloon filling port configured to allow for the balloon to be inflated/deflated, the balloon filling portion port is separate from the air/fluid injection port.
